(19) United States
(12) Patent Application Publication
(10) Pub. No.: US 2017/0294140 A1
(43) Pub. Date: Oct. 12, 2017

(54) CERTIFICATE OF ADDITION TO SPANISH PATENT NO. ES 2 438 440 ENTITLED "ADVANCED DEVICE FOR WELDING TRAINING BASED ON SIMULATION WITH AUGMENTED REALITY AND REMOTELY UPDATABLE"

(71) Applicant: SEABERY SOLUCIONES S.L., Huelva (ES)

(72) Inventors: Juan Jose CHICA BARRERA, Huelva (ES); Francisco Jose AGUILAR NIETO, Huelva (ES); Basilio MARQUINEZ GARCIA, Huelva (ES); Alejandro VILLARAN VAZQUEZ, Huelva (ES)

(21) Appl. No.: 15/512,857

(22) PCT Filed: Sep. 8, 2015
(86) PCT No.: PCT/ES2015/070653

§ 371 Date: Mar. 21, 2017

(30) Foreign Application Priority Data
Sep. 22, 2014 (ES) P201431371

(51) Int. Cl. G09B 19/24; G09B 9/00; G09B 19/00

(52) U.S. Cl. CPC G09B 19/24; G09B 19/003; G09B 9/00

(57) ABSTRACT

Certificate of addition to the Spanish patent ES 24 38 440 “Advanced device for the welding training based on simulation with Augmented Reality and with remote updates”, has now an additional simulation over the electrode and an improved welding mask which enhances both the immersive experience and the user's sensations in order to provide more scenarios for the invention application in both the simulated and real welding.

Certificate of addition to the Spanish patent ES 24 38 440 “Advanced device for the welding training based on simulation with Augmented Reality and with remote updates.

### SUBJECT MATTER OF THE INVENTION

Certificate of addition to the Spanish patent ES 24 38 440 “Advanced device for the welding training based on simulation with Augmented Reality and with remote updates” based on the elements and demands of the above main patent, providing new characteristics and inventive activity.

### BACKGROUND OF THE STATE OF THE TECHNIQUE

The main patent consists on a technological device created for its application to the welding training and it allows the simulation of all the welding processes in a very accurate way through the Augmented Reality. It also simulates the behavior of a real welding machine which is implemented over a control, monitoring and evaluation system, so the students' teaching process is checked in real time by the instructor without the necessity of being physically present in the training room. For that reason, the main patent describes the following components included in the device:
1. CPU unit.
2. Real MIG/MAG (GMAW, FCAW) and TIG (GTAW) welding torches that are adapted by modifying their tip which is replaced by an invented tip that incorporates a system of Augmented Reality markers.
3. Real electrode clamp to hold both the simulated electrode stick and the TIG rod.
4. Welding coupons (work pieces).
5. Work stand.
6. Welding mask with an incorporated Augmented Reality system.
7. Operating system based on a Linux version (open source) that has been enhanced for the specific requirements of the system.
8. Necessary network architecture.
9. Implementation of mathematical algorithms that are able to simulate in 3D a real welding process with all its variables.
10. Data matrices that anticipate the exact behavior of a welding machine.
11. Technical and quality system of the performed welding.
12. Usage context menus.
13. Human-machine interfaces.
14. Remote updating system of any of the variables of the system (e.g. Welding materials) through the Software.
15. Necessary Software libraries for the incorporation of the Augmented Reality.

### DESCRIPTION OF THE INVENTION

In relation to the Spanish patent ES 24 38 440, the invention has now an additional simulation over the electrode and an improved welding mask which enhances both the immersive experience and the user's sensation in basis of the introduction of the following improvements:

1.—Retractile electrode whose consumption is simulated through the pulling movement of the rod. It is composed of the following elements:
a) Main section of the rod that simulates the coated electrode.
b) Segment of the rod for the recognition of the artificial vision technology.
c) Pulling device that holds the electrode stick and drags it using the appropriate speed for the electrode consumption.
d) Angle adjustment to position the whole electrode set.
e) Electrode clamp.
f) Grip handle.
g) Set of rollers, nuts and screws.
h) Control electronic board of the pulling engine.
i) Micro motor.
j) Plastic roller guide.

Thus, the retractile electrode is complemented with mechanical, electro-mechanical and electronic devices that allow it to communicate through a digital data bus, with the operator system and with the IT system improving the simulation of the electrode consumption, based on the selected welding parameters by the user, that is similar to the real welding.

2.—Welding mask with an improved Augmented Reality system which is composed of the following elements:
a) Front bezel which consists on a cover fixed to the mirrors frame. It works as a bezel and it also protects all the different elements that are very vulnerable to breakage as the cameras, the lightning system and the speaker.
b) Speaker.
c) Lightning system.
d) Cameras which capture the video image and bring it to the computer, so it can be processed to bring it back to the user through the LCD screen and the mirrors.
e) LED frame which keeps the lightnig system and provides refrigeration through the aluminum body.
f) Cameras frame which consits on a support with the exact measures for the cameras fixation to the mirrors frame.
g) Mirrors frame where both the mirrors and LCD screen are fixed.
h) Secondary mirror.
i) Primary mirror.
j) LCD screen which consists on a display or a high resolution commercial LCD. It projects the image to the user from the primary and secondary mirrors.
k) Cover frame with the required serigraphy.
l) Anti-fog protector that protects both the LCD screen and the primary and secondary mirrors and avoid an innapropriate manipulation of the mask.
m) Head-mounted display that is fixed to mirrors fram and can be adjusted to any commercial helmet suspension. This piece, together with the helmet suspension, achieves the necessary adjustments for an appropriate position of the Augmented Mask.

Thus, the improved welding mask with the Augmented Reality system is configured according to a multimedia player (audio included). It is composed of a lightning and vision system included in the mask itself and incorporates a primary mirror which, together with the screen, forms an angle of between 40 and 50 grades; and a secondary mirror that, together with the primary one, forms and angle of between 62 and 72 grades. Thanks to this, a more panoramic perspective with a higher resolution is obtained by the user in any type of the multimedia content.

As an additional innovation and due to the use of the improved devices (electrode and mask), this certificate of addition allows working using two color cameras (both the resolution and the cameras frame depend on the required application type, always trying to reach a balance between functionality and cost to guarantee its commercial viability); a color camera or the combination of a color camera and a time flight one (for the 3D objects recognition when the use of the Augmented Reality markers of the original invention is possible), depending on the different applications of the invention, this allows the device to be applied, as an innovation with respect to the main patent (whose principal objective is the welding simulation), to both the simulated and real welding, helping welders to recognize real welding scenarios, offering tips to increase the productivity (cost and time savings), improving quality and reducing accidents.

In this sense, the primary mirror described in this patent of addition, has an spherical curvature to zoom in the image according to the necessities of either the simulated welding or the real one.

Simlarly, in relation to the above mentioned LCD screen, one can work with it or with 2 micro displays for each eye, to improve the 3D experience according to the necessities of either the simulated welding or the real one.

For that reason, the evolution of the Hardware elements described in the inventions, has resulted in a research on new detection systems of the different elements to help the user in the practice not only of the simulated welding, but of the real one.

### FIGURES DESCRIPTION

To complete the description and for the purpose of facilitating the comprehension of the invention characteristics, this patent of addition is accompanied by a set of figures that represent the following:

FIG. 1.—Perspective view of the retractile electrode.

FIG. 2.—Upper posterior view of the retractile eclectrode.

FIG. 3.—Exploded view of the retractile electrode.

FIG. 4.—Perspective view of the welding mask with an improved Augmented Reality system.

FIG. 5.—Exploded view of the welding mask with an improved Augmented Reality system.

FIG. 6.—Detailed relative positions between the LCD screen and both the primary and seconsary mirrors of the welding mask with an improved Augmented Reality system.

In the above-mentioned figures, the following elements can be highlighted:
1. Main body of the electrode stick.
2. Electrode stick segment for the recognition through the Augmented Reality.
3. Pulling mechanism.
4. Angle adjustment.
5. Electrode clamp.
6. Grip holder.
7. Set of rollers, nuts and screws.
8. Control electronic board of the pulling engine.
9. Micro motor.
10. Plastic roller guide.
11. Front bezel.
12. Speaker.
13. Lightning system.
14. Cameras
15. LED frame.
16. Cameras frame.
17. Mirrors frame.
18. Secondary mirror.
19. Primary mirror.
20. LCD screen.
21. Cover bezel.
22. Anti-fog protector.
23. Head-mounted display.

### EXAMPLE OF PREFERRED EMBODIMENT OF THE INVENTION

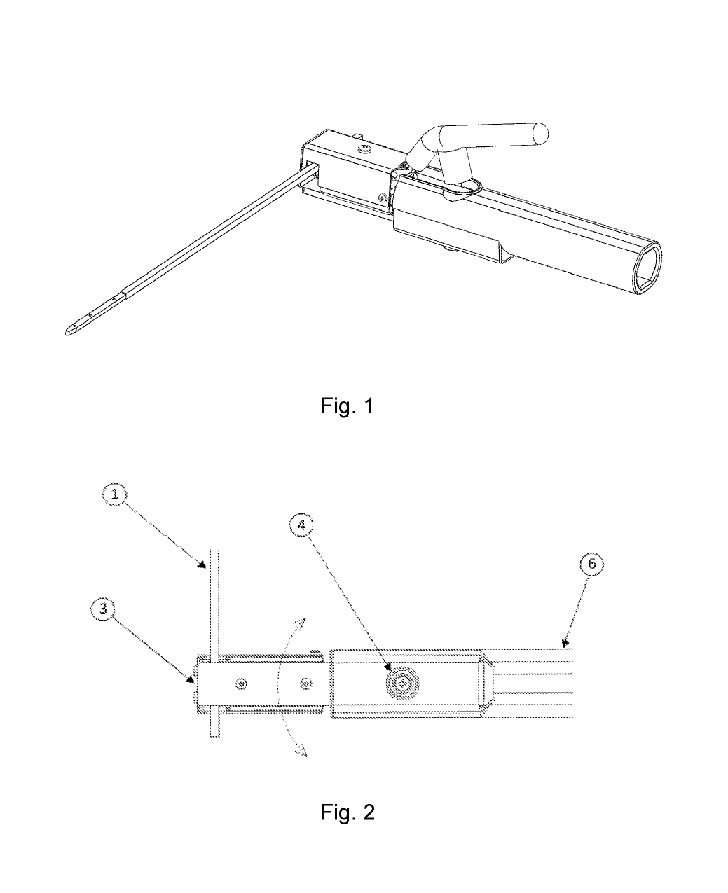

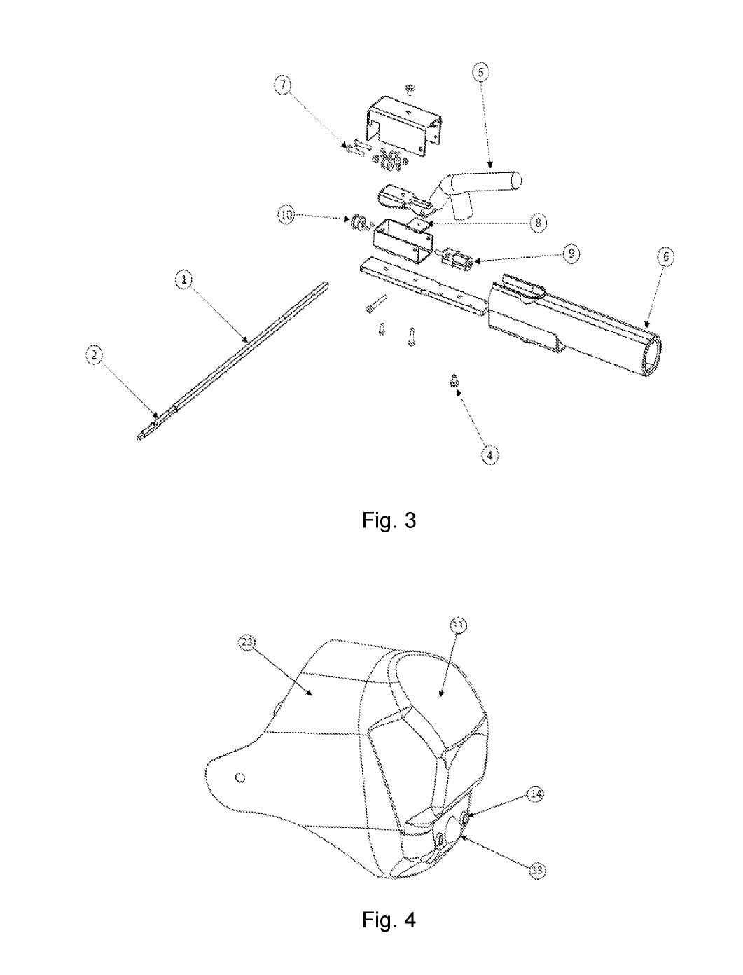

In FIGS. 1 to 3, it can be observed that the retractile electrode is obtained from the main body of the electrode stick (1) made of plastic or metal and in a cylindrical or square shape to which an electrode stick segment is added for the Augmented Reality recognition (2). It can be made of a color code, lighted points or of an electrode stick extension. Thereon, it will be possible to recognize a real coated electrode.

This set is complemented by a pulling mechanism (3) which holds the electrode stick (1) and drags it using an appropriate speed for the simulation of the electrode consumption. This set is also composed of more mechanical and electronic pieces that are responsible for the consumption movement. Those pieces consist on:
a) Set of rollers, nuts and screws (7) that put the exact pressure on the consumption movements through the plastic roller guide (10).
b) Electronic programmable board (8) that generates the electrode appropriate movement and speed (1) in the simulation of the material consumption.
c) Micro motor (9) with a mechanical reducing and a detection system through a digital encoder. The micro motor output is connected to the plastic roller guide (10) to generate traction over the electrode stick.
d) Plastic roller guide (10) which transmits the micro motor (9) movement and generates the electrode stick movement that simulates the consumption in the welding process.

Finally, the retractile electrode set is complemented by the main angle adjustment to put the whole set in the required angle depending on the welding position. This angle adjustment allows an anti-clockwise rotation up to 45 grades. The electrode clamp (5) is adjustable and guarantees the electrode stick (1) fixing with the plastic roller guide (10) and the main body. It is quite cylindrical and its ergonomics has been adapted to facilitate its holding with both hands. To this last piece, both the traction mechanism and the electrode clamp are fixed through the angle controller for the electrode configuration.

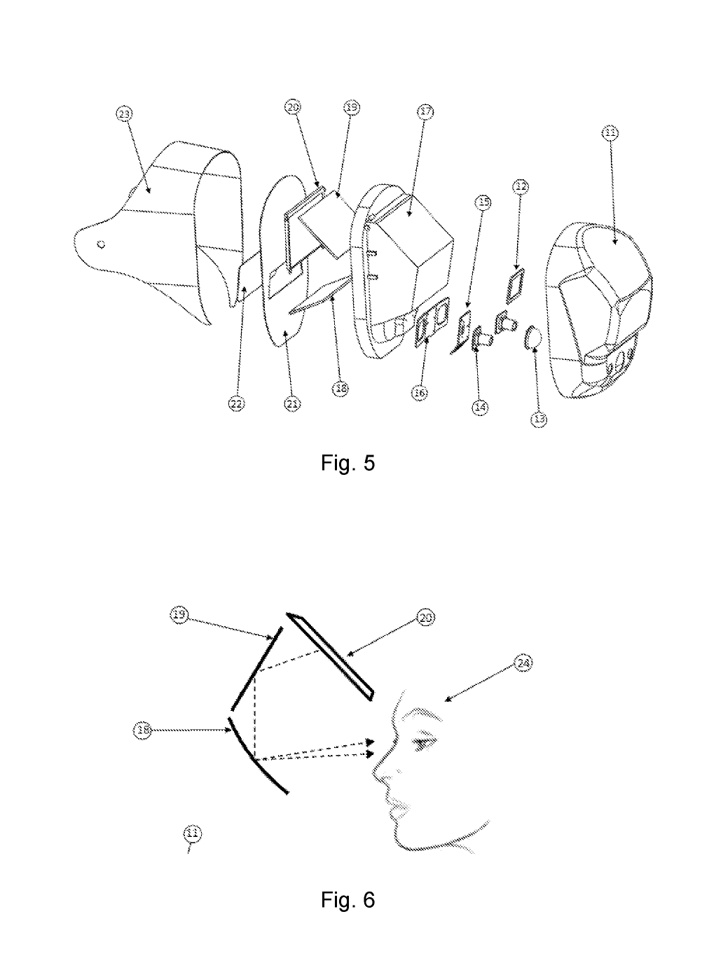

Regarding the manufacturing of the improved welding mask with Augmented Reality system and as it can be observed in FIGS. 4 to 6, it is composed for the following elements:
Frontal bezel (11) made of thermo-shaped plastic and fixed to the mirrors frame (17). It protects all the shock sensitive elements as the cameras (14), the lightning system (13) and the speaker (12).
Membrane speaker which reproduces the sorround sound assisted by a sounding board that is produced between the bezel (11) and the mirrors frame (17).
Lightning system (13) which consists on a uniform light source without any bright points. This is possible because of the combination between a high brightness light source and a hemispherical white diffuser.
   Cameras (14) which capture the video image and bring it to the computer, so it can be processed to bring it back to the user through the LCD screen (20) and the mirrors (19) (18).
LED frame (15) which stores the lightning system (13) and provides refrigeration through the aluminum body.
Cameras frame (16) which consits on a support with the exact measures for the cameras fixation (14) to the mirrors frame (17).
Mirrors frame (17) made of thermo-shaped plastic. Both mirrors (18) (19) are fixed to it and it keeps the correct position of the LCD screen and the correct angles to achieve an appropriate image projection.
Secondary mirror (18) equipped with a special treatment in the surface for a mirror finish because the use of glass is inappropriate. This mirror has a spherical curvature to zoom in the image according to the different scenarios of both the simulated welding and the real one.
Primary mirror (19) with a special treatment in the surface for a mirror finish. This mirror does not have curvature.
High resolution LCD screen that can be flat or can use the OLED technology. Its main objective is to project the image to the user through the mirrors (18) (19).
Cover bezel (21) which protects the LCD screen (20) and has the required serigraphy.
Anti-fog protector (22) that protects the LCD screen (20) and both mirrors (18) (19). It also has other functions like covering the output hole of the user's field of vision and protecting the mask from an inappropriate manipulation.
Head-mounted display that is fixed to mirrors fram and can be adjusted to any commercial helmet suspension. This piece, together with the helmet suspension, achieves the necessary adjustments for an appropriate position of the Augmented Mask.

Finally, as it can be observed in FIG. 6, it is important to highlight the relative positions between the primary mirror (19) and the screen (20) where there is an angle of between 40 and 50 grades with a central position of 45 grades. Between the secondary mirror (18) and the primary one (19) there is angle of between 62 and 72 grades with a central position of 70 grades approximately.

All the described improvements and the extension of the detection system of all the elements that form a real welding scenario: work pieces with different joint types, welding torches, electrode stick and the TIG filler rod (used in the main patent); allow the device to carry out the following actions:
a) Elements and objects learning:
   The learning process consist on the device detection of all the interest points of an element. All these interest points are classified and, those that are repeated or less solid, are refused. The classified point cloud will be the description of the object for our Augmented Reality system.
b) Element detection:
   The detection of the element is carried out by the device through a search of the interest point in a scenario captured by the cameras. Once those points are obtained, there is a search algorithm to look for concordance between the interest points described before.
c) Calculation of the position and the orientation of the elements in space:
   Since the device stores all the 3D information of each element, the position of the cameras and the 3D object can be calculated.
d) Elements tracking:
   To avoid false positives or inappropriate movements of the elements, an algorithm has been developed to filter them out.
e) Augmented Reality:
   Previously, the position of the cameras set, that is used to putt he virtual camera in the same position as the real one, has been obtained. Thus, when the virtual object is placed, the same perspective will be obtained and it will create the impression of having a virtual object in the reality itself.

It is not considered necessary to extend this description because the main scope of the invention can be understood by any subject matter expert. All the elements that form the invention or its implementation technique, may change provided that it does not involve any important change in the invention essence.

1. Certificate of addition to the U.S. patent application Ser. No. 14/406,228 “Advanced device for the welding training based on simulation with Augmented Reality and with remote updates” which incorporates the following elements:
Retractile electrode whose consumption is simulated through the pulling movement of the rod. It is composed of the following elements:
a) Main section of the rod that simulates the coated electrode.
b) Segment of the rod for the recognition of the artificial vision technology.
c) Pulling device that holds the electrode stick and drags it using the appropriate speed for the electrode consumption.
d) Angle adjustment to position the whole electrode set.
e) Electrode clamp.
f) Grip handle.
g) Set of rollers, nuts and screws.
h) Control electronic board of the pulling engine.
i) Micro motor.
j) Plastic roller guide.
Welding mask with an improved Augmented Reality system which is composed of the following elements:
a) Front bezel which consists on a cover fixed to the mirrors frame. It works as a bezel and it also protects all the different elements that are very vulnerable to breakage as the cameras, the lightning system and the speaker.
b) Speaker.
c) Lightning system.
d) Cameras which capture the video image and bring it to the computer, so it can be processed to bring it back to the user through the LCD screen and the mirrors.
e) LED frame which keeps the lightnig system and provides refrigeration through the aluminum body.
f) Cameras frame which consits on a support with the exact measures for the cameras fixation to the mirrors frame.
g) Mirrors frame where both the mirrors and LCD screen are fixed.
h) Secondary mirror.
i) Primary mirror.
j) LCD screen which consists on a display or a high resolution commercial LCD. It projects the image to the user from the primary and secondary mirrors.
k) Cover frame with the required serigraphy.
l) Anti-fog protector that protects both the LCD screen and the primary and secondary mirrors and avoid an innapropriate manipulation of the mask.
m) Head-mounted display that is fixed to mirrors fram and can be adjusted to any commercial helmet suspension. This piece, together with the helmet suspension, achieves the necessary adjustments for an appropriate position of the Augmented Mask.

2. Certificate of addition to U.S. patent application Ser. No. 14/406,228 “Advanced device for the welding training based on simulation using the Augmented Reality and with a remote updating system”, according to claim 1, characterized by the retractile electrode is complemented with mechanical, electro-mechanical and electronic devices that allow it to communicate through a digital data bus, with the operator system and with the IT system improving the simulation of the electrode consumption, based on the selected welding parameters by the user, that is similar to the real welding.

3. Certificate of addition to the U.S. patent application Ser. No. 14/406,228 “Advanced device for the welding training based on simulation using the Augmented Reality and with a remote updating system”, according to claim 1, characterized by the improved welding mask with the Augmented Reality system is configured according to a multimedia player (audio included). It is composed of a lightning and vision system included in the mask itself and incorporates a primary mirror which, together with the screen, forms an angle of between 40 and 50 grades; and a secondary mirror that, together with the primary one, forms and angle of between 62 and 72 grades. Thanks to this, a more panoramic perspective with a higher resolution is obtained by the user in any type of the multimedia content.

4. Certificate of addition to the U.S. patent application Ser. No. 14/406,228 “Advanced device for the welding training based on simulation using the Augmented Reality and with a remote updating system”, according to claim 1, all the described improvements and the extension of the detection system of all the elements that form a real welding scenario: work pieces with different joint types, welding torches, electrode stick and the TIG filler rod (used in the main patent); allow the device to carry out the following actions:
a) Elements and objects learning:
The learning process consist on the device detection of all the interest points of an element. All these interest points are classified and, those that are repeated or less solid, are refused. The classified point cloud will be the description of the object for our Augmented Reality system.
b) Element detection:
The detection of the element is carried out by the device through a search of the interest point in a scenario captured by the cameras. Once those points are obtained, there is a search algorithm to look for concordance between the interest points described before.
c) Calculation of the position and the orientation of the elements in space:
Since the device stores all the 3D information of each element, the position of the cameras and the 3D object can be calculated.
d) Elements tracking:
To avoid false positives or inappropriate movements of the elements, an algorithm has been developed to filter them out.
e) Augmented Reality:
Previously, the position of the cameras set, that is used to put the virtual camera in the same position as the real one, has been obtained. Thus, when the virtual object is placed, the same perspective will be obtained and it will create the impression of having a virtual object in the reality itself.
